(19) United States
(12) Patent Application Publication
(10) Pub. No.: US 2026/0278864 A1
(43) Pub. Date: Sep. 17, 2026

(54) DETECTING AND CREATING INTERTWINED GRAPHICS IN VECTOR-BASED DESIGNS

(71) Applicant: Adobe Inc., San Jose, CA (US)

(72) Inventors: Harish Kumar, Noida (IN); Praveen Kumar Dhanuka, Howrah (IN); Apurva Kumar, Patna (IN)

(21) Appl. No.: 19/080,113

(22) Filed: Mar. 14, 2025

(51) Int. Cl. G06T 11/20; G06F 3/04845; G06T 11/60

(52) U.S. Cl. CPC G06T 11/23; G06F 3/04845; G06T 11/60

(57) ABSTRACT

The present disclosure relates to systems, non-transitory computer-readable media, and methods for detecting and creating intertwine groups of vector objects in vector-based designs. In particular, the disclosed systems access a vector graphic file comprising a plurality of vector objects. Additionally, the disclosed systems determine, by at least one processor, that the plurality of vector objects comprises an intertwined group of vector objects. For example, the disclosed systems determine that the plurality of vector objects comprise one or more clipping groups. Moreover, the disclosed systems determine that the one or more clipping groups are spatially mutually exclusive or a non-clipping path object intersects with a union of clipping path boundaries of the one or more clipping groups.

### BACKGROUND

Recent years have seen significant improvements in hardware and software platforms for creating and modifying digital designs. For example, many platforms offer software applications that edit objects within a digital design. To illustrate, some image processing applications enable localized reordering of portions of vector objects to create an appearance of depth between the portions of the vector objects. For example, in some cases, some image processing applications reorder portions of vector objects such a portion of a first vector object appears above a second vector object, while other portions of the first vector object appear below the second vector object to generate an “intertwined” appearance. Although many existing systems generate intertwined vector objects, many of these existing systems have a number of shortcomings, particularly with regards to accurately, efficiently, and flexibly editing such intertwined objects.

### SUMMARY

Embodiments of the present disclosure provide benefits and/or solve one or more of the foregoing or other problems in the art with systems, non-transitory computer-readable media, and methods for automatically detecting and creating intertwine groups from overlapping vector objects in vector-based designs. Once intertwine groups are created, the disclosed systems allows for intuitive editing and re-ordering of vector objects in the intertwine groups. In particular, the disclosed systems detect intertwine groups at locations vector objects intersect and intertwine. Further, the disclosed systems reconstruct the intertwine groups based on overlapping zones and visual orders of the vector objects in the overlapping zones. For example, the disclosed systems generate overlapping zones based on the detected intertwine groups, determine the visual order of the vector objects in each overlapping zone, and generate modifiable intertwine groups of the vector objects corresponding to the overlapping zones. Thus, the disclosed systems extract intertwining vector objects from the vector-based design with all the information required to automatically edit/modify the visually intertwining appearance of the vector objects with minimal user input.

Additional features and advantages of one or more embodiments of the present disclosure are outlined in the description which follows, and in part are determined from the description, or are learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which an intertwined object detection system operates in accordance with one or more embodiments.

FIG. 2 illustrates an overview diagram of the intertwined object detection system automatically detecting, creating, and modifying intertwine groups of vector objects in accordance with one or more embodiments.

FIG. 3 illustrates a diagram of the intertwined object detection system determining an intertwined group of vector objects in accordance with one or more embodiments.

FIG. 4 illustrates a diagram of the intertwined object detection system determining overlapping zones of intertwining vector objects in accordance with one or more embodiments.

FIG. 5 illustrates a diagram of the intertwined object detection system determining a visual order of intertwining vector objects within overlapping zones in accordance with one or more embodiments.

FIG. 6 illustrates an example graphical user interface that the intertwined object detection system uses to modify a visual order of intertwined vector objects in accordance with one or more embodiments.

FIG. 7 illustrates an example schematic diagram of the intertwined object detection system in accordance with one or more embodiments.

FIG. 8 illustrates a flowchart of an example series of acts for determining an intertwined group of vector objects in a vector graphic file in accordance with one or more embodiments.

FIG. 9 illustrates a flowchart of an example series of acts for determining a visual order of intertwining objects within a vector graphic file in accordance with one or more embodiments.

FIG. 10 illustrates a flowchart of an example series of acts for modifying a visual order of intertwining vector objects within a vector graphic file in accordance with one or more embodiments.

FIG. 11 illustrates a block diagram of an example computing device for implementing one or more embodiments of the present disclosure.

### DETAILED DESCRIPTION

This disclosure describes one or more embodiments of an intertwined object detection system for automatically detecting and creating intertwine groups of vector objects in vector-based designs in response to minimal user inputs. In particular, the intertwined object detection system automatically detects intertwine groups at locations of a vector graphic file where vector objects intertwine in response to minimal user interactions (e.g., a single user input). The intertwined object detection system further automatically reconstructs the intertwine groups based on overlapping zones and visual orders of the vector objects in the overlapping zones. For example, the intertwined object detection system generates overlapping zones, determines the visual order of the vector objects in each overlapping zone, and generates modifiable intertwine groups of the vector objects corresponding to the overlapping zones. Further, the intertwined object detection system modifies the intertwining appearance of the intertwined vector objects by reordering the visual order of the vector objects using the modifiable intertwine groups.

As mentioned above, in some embodiments, the intertwined object detection system detects intertwine groups at locations of a vector graphic file where vector objects intertwine. Specifically, the intertwined object detection system automatically detects the intertwine groups in response to minimal user inputs (e.g., a single input) based on identifying clipping groups within the vector graphic file. Moreover, in some implementations, the intertwined object detection system utilizes the relative locations of the clipping groups and non-clipping path objects to determine intertwined groups of vector objects (i.e., the intertwine groups).

As noted above, in one or more embodiments, the intertwined object detection system automatically reconstructs the intertwine groups based on overlapping zones and visual orders of the vector objects in the overlapping zones. In particular, the intertwined object detection system determines overlapping zones based on the clipping paths (e.g., closed paths). For example, in one or more implementations, the intertwined object detection system determines the overlapping zones by identifying that a closed path does not intersect with any other closed path or by identifying intersecting closed paths. Furthermore, in some embodiments, the intertwined object detection system generates the overlapping zones based on the determined overlapping zones.

As mentioned previously, in some implementations, the intertwined object detection system automatically determines the visual order of the vector objects in each overlapping zone. Specifically, the intertwined object detection system iterates through the vector objects in each zone in reverse z-order to determine the visual order of the vector objects. For example, the intertwined object detection system determines the visual order of the vector objects by determining closed paths within an overlapping zone. In particular, the intertwined object detection system adds the vector object that does not have a closed path within the overlapping zone to the top of the array indicating that this vector object is the highest (i.e., visually on top) within the overlapping zone.

As noted previously, in one or more embodiments, the intertwined object detection system modifies the intertwining appearance of the intertwined vector objects by reordering the visual order of the vector objects using the intertwine groups. Specifically, the intertwined object detection system modifies the intertwining appearance of the vector objects in response to a user input to modify the visual order of the intertwining vector objects. For example, in one or more implementations, the intertwined object detection system automatically modifies the visual order of the vector objects in each overlapping zone using the intertwine groups in response to a single user input.

Although conventional systems provide various tools for modifying objects in digital designs to achieve vector object intertwining effects, conventional systems have a number of disadvantages with respect to efficiency. For instance, conventional systems inefficiently modify digital design objects by requiring numerous user interactions to prepare objects for design effects such as object intertwining. More specifically, conventional systems require that a user manually determine the z-order of objects in a file, determine the visual order of the objects at each location where objects intersect to determine locations at which intertwining of objects is in effect, and construct an intertwine group at each intertwining location in order to modify the intertwining effect. Thus, to construct an intertwine group for automatically editing the intertwining appearance of objects conventional systems require use of various user interface tools, menus, and user interactions. The more complex the intertwining effect, the more resources are required to achieve the effect. This inefficiency is particularly problematic in cases of complex intertwining designs having many intersections between objects.

As suggested by the foregoing, the intertwined object detection system provides a variety of advantages relative to conventional systems. For example, by automatically detecting and creating intertwine groups the intertwined object detection system improves efficiency relative to conventional systems. Specifically, in some embodiments, the intertwined object detection system automatically detects locations at which vector objects are intertwined and generates an intertwine group for further editing of the intertwining of the vector objects by receiving a single interaction. Thus, the need for manual detection and creation of modifiable intertwine groups is avoided by the intertwined object detection system. Specifically, the intertwined object detection system avoids the need for manual detection of locations where objects are intertwining, manual determination of z-order of the objects, and multiple inputs such as inputs at each intertwining location to generate the automatically modifiable intertwine groups is avoided by the intertwined object detection system.

Additionally, the intertwined object detection system provides improved graphical user interfaces for generating intertwined objects. In contrast to conventional systems that require users to access and use a number of different graphical user interface tools, menus, and interactions to manually create modifiable intertwine groups for automatically editing the intertwining of objects, the intertwined object detection system provides a graphical user interface and system that generates modifiable intertwined objects in response to minimal user interaction. More specifically, the intertwined object detection system detects and creates the intertwine groups for each intertwining location within a design in response to a single interaction within a graphical user interface (e.g., a single button click).

Additionally, the intertwined object detection system enhances cross-product compatibility. For example, an intertwine group created in a vector editing software application then converted into a standard file format (e.g., PDF, SVG, EMF) often loses any metadata defining the intertwine group. As such, once imported back into a vector editing software, a user is typically required to perform the manual and tedious process of reconstructing the intertwine group as noted above. The ability of the intertwined object detection system to automatically (e.g., in response to a single user input) generate intertwine groups enables designers to leverage the computing performance and ease of editing of the vector editing software, which improves their productivity. Furthermore, different vector editing software applications often lack compatibility with respect to intertwine groups. For example, some systems require manual creation and manipulation of intertwine groups. The intertwined object detection system provides for cross-product compatibility by allowing for importation of intertwining objects created in another software application to be automatically converted into an intertwine group that is understood by the intertwined object detection system, and thus, provided with the ability to easily and intuitively edit such intertwine groups with minimal user input.

Moreover, by automatically intertwining objects with minimal interactions the intertwined object detection system improves flexibility relative to conventional systems. Specifically, in one or more embodiments, the intertwined object detection system quickly and easily intertwines (e.g., by a single interaction) even complex designs with many objects and many overlapping surfaces. Thus, the intertwined object detection system improves upon flexibility of operation compared to conventional systems. Moreover, in some embodiments, even after selection of an intertwining option between objects from among multiple options, the intertwined object detection system allows for a user to modify the ordering of one or more specific overlap surfaces between objects and automatically adjusts the remaining overlapping surfaces in the design to maintain the intertwining effect. Thus, the s intertwined object detection system allows for flexible manual adjustments to the intertwining design with minimal interactions while maintaining the improved efficiency as described above.

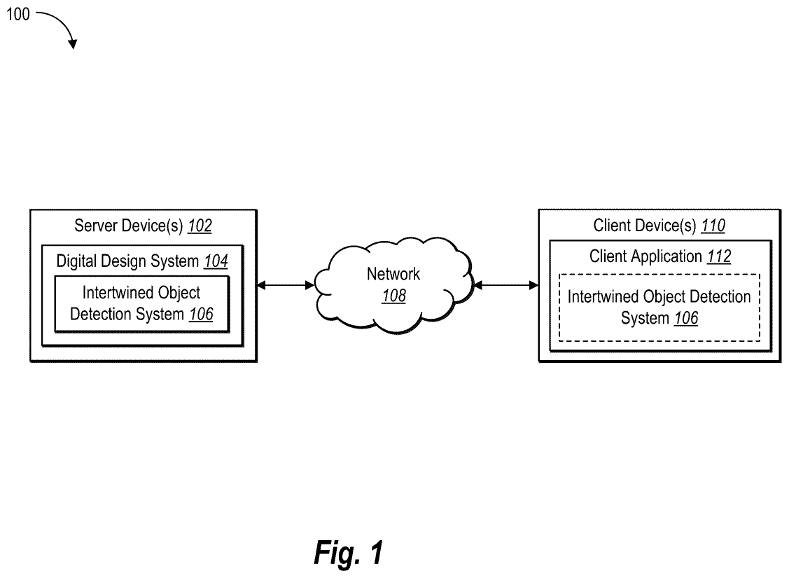

Additional detail regarding the intertwined object detection system will now be provided with reference to the figures. For example, FIG. 1 illustrates a schematic diagram of an exemplary system 100 in which an intertwined object detection system 106 operates. As illustrated in FIG. 1, the system 100 includes a server device(s) 102, a network 108, and a client device(s) 110. Although the system 100 of FIG. 1 is depicted as having a particular number of components, the system 100 is capable of having any number of additional or alternative components (e.g., any number of servers, client devices, or other components in communication with the intertwined object detection system 106 via the network 108). Similarly, although FIG. 1 illustrates a particular arrangement of the server device(s) 102, the network 108, and the client device(s) 110, various additional arrangements are possible.

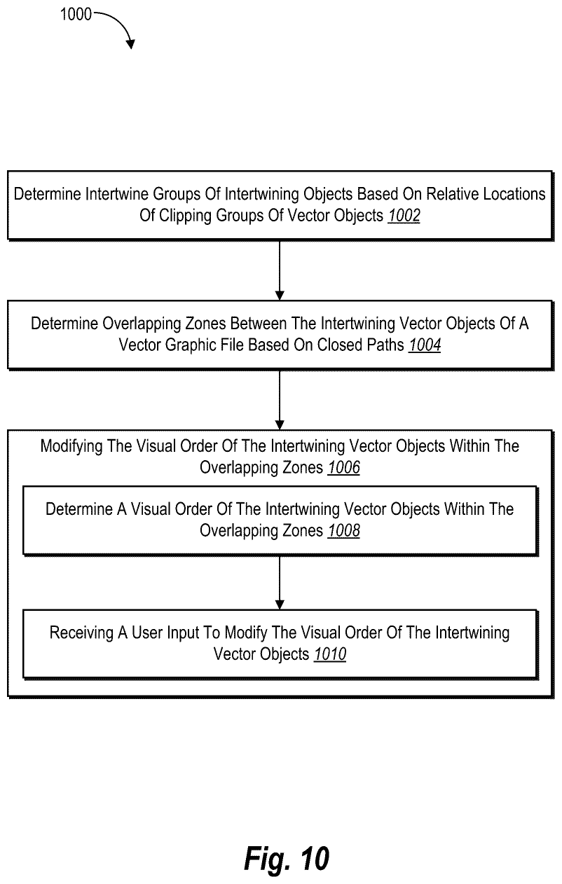

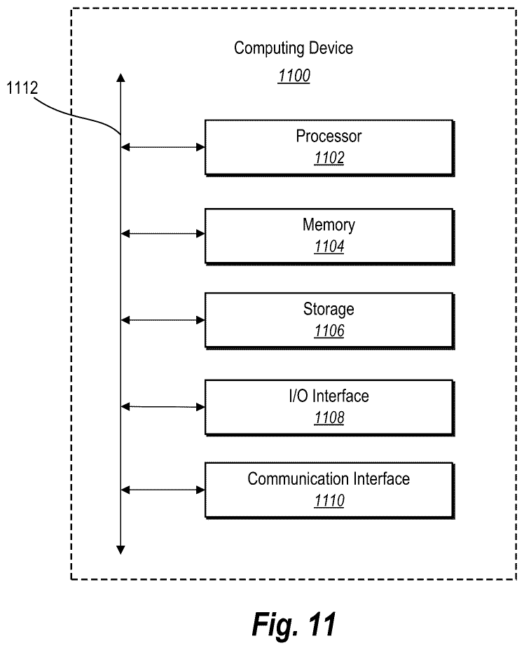

The server device(s) 102, the network 108, and the client device(s) 110 are communicatively coupled with each other either directly or indirectly (e.g., through the network 108 discussed in greater detail below in relation to FIG. 11). Moreover, the server device(s) 102 and the client device(s) 110 include one or more of a variety of computing devices (including one or more computing devices as discussed in greater detail with relation to FIG. 10).

As mentioned above, the system 100 includes the server device(s) 102. In one or more embodiments, the server device(s) 102 generates, stores, receives, and/or transmits data including notifications, models, and digital designs. In one or more embodiments, the server device(s) 102 comprises a data server. In some implementations, the server device(s) 102 comprises a communication server or a web-hosting server. Further, the server device(s) 102 includes a digital design system 104 which further includes the intertwined object detection system 106.

In one or more embodiments, the client device(s) 110 includes computing devices that access, edit, segment, modify, store, and/or provide, for display, digital content such as digital designs. For example, the client device(s) 110 includes smartphones, tablets, desktop computers, laptop computers, head-mounted-display devices, or other electronic devices. The client device(s) 110 includes one or more applications (e.g., a client application 112) that access, edit, segment, modify, store, and/or provide, for display, digital content such as digital designs. For example, in one or more embodiments, the client application 112 includes a software application installed on the client device(s) 110. Additionally, or alternatively, the client application 112 includes a software application hosted on the server device(s) 102 which are accessible by the client device(s) 110 through another application, such as a web browser.

To provide an example implementation, in some embodiments, the intertwined object detection system 106 on the server device(s) 102 supports the intertwined object detection system 106 on the client device(s) 110. In other words, the client device(s) 110 obtains (e.g., downloads) the intertwined object detection system 106 from the server device(s) 102. Once downloaded, the intertwined object detection system 106 on the client device(s) 110 detects and generates intertwine groups and modifies intertwined digital designs by ordering the overlapping surfaces of objects in accordance with a modified visual order.

In alternative implementations, the intertwined object detection system 106 includes a web hosting application that allows the client device(s) 110 to interact with content and services hosted on the server device(s) 102. To illustrate, in one or more implementations, the client device(s) 110 accesses a software application supported by the server device(s) 102. In response, the intertwined object detection system 106 on the server device(s) 102 detects and generates intertwine groups and provides a modified intertwined digital design. The server device(s) 102 then provides the intertwined digital design to the client device(s) 110 for display.

To illustrate, in some cases, the intertwined object detection system 106 on the client device(s) 110 detects and generates intertwine groups based on clipping groups within the vector graphic file via a software application supported by the server device(s) 102. The client device(s) 110 transmits the generated intertwine groups to the server device(s) 102. In response, the intertwined object detection system 106 on the server device(s) 102 further modifies the visual order of the objects via the intertwine groups.

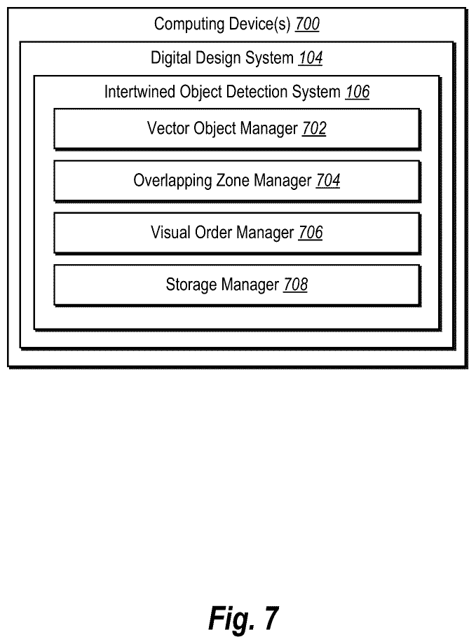

While, although FIG. 1 illustrates the intertwined object detection system 106 implemented with regard to the server device(s) 102, different components of the intertwined object detection system 106 are able to be implemented by a variety of devices within the system 100. For example, a different computing device (e.g., the client device(s) 110) or a separate server from the server device(s) 102 implement one or more (or all) components of the intertwined object detection system 106. Indeed, as shown in FIG. 1, the client device(s) 110 includes the intertwined object detection system 106. Example components of the intertwined object detection system 106 will be described below with regard to FIG. 7.

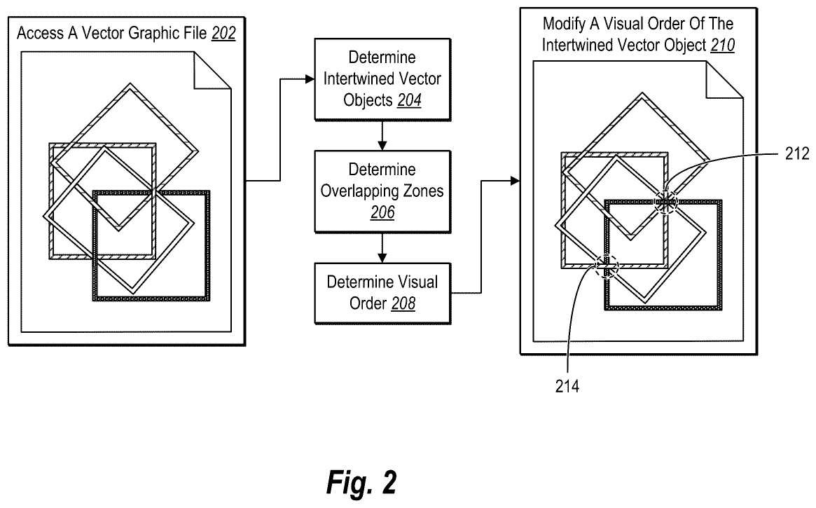

As previously mentioned, in some embodiments, the intertwined object detection system 106 automatically detects and creates intertwine groups of vector objects in a vector graphic file. For instance, the intertwined object detection system 106 detects and creates the intertwine groups in response to minimal user interaction via a graphical user interface of a client device. FIG. 2 illustrates an overview diagram of the intertwined object detection system 106 automatically detecting, creating, and modifying intertwine groups of vector objects in accordance with one or more embodiments.

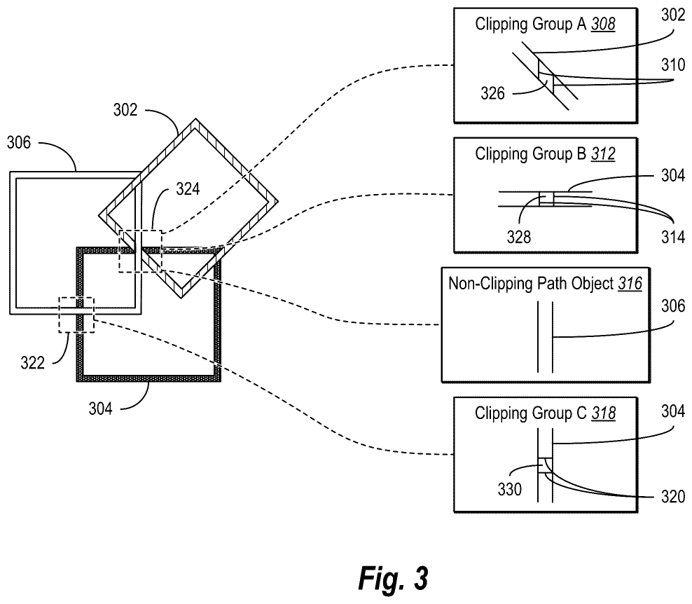

As illustrated in FIG. 2, in some implementations, the intertwined object detection system 106 performs an act 202 of accessing a vector graphic file. In particular, the intertwined object detection system 106 accesses the vector graphic file to further perform an act 204 of determining intertwined vector objects. For example, the intertwined object detection system 106 determines that the vector graphic file includes vector objects (e.g., the rectangles) and that the vector objects include intertwined groups of vector objects (or simply intertwine groups). To illustrate, in one or more embodiments, the intertwined object detection system 106 determines intertwine groups at one or more locations where the vector objects visually intersect based on clipping groups within the vector graphic file. In one or more implementations, intersecting vector objects, clipping paths, closed groups, and/or overlapping zones intersect in the x-y plane. Additional detail regarding determining intertwine groups of vector objects is provided with respect to FIG. 3.

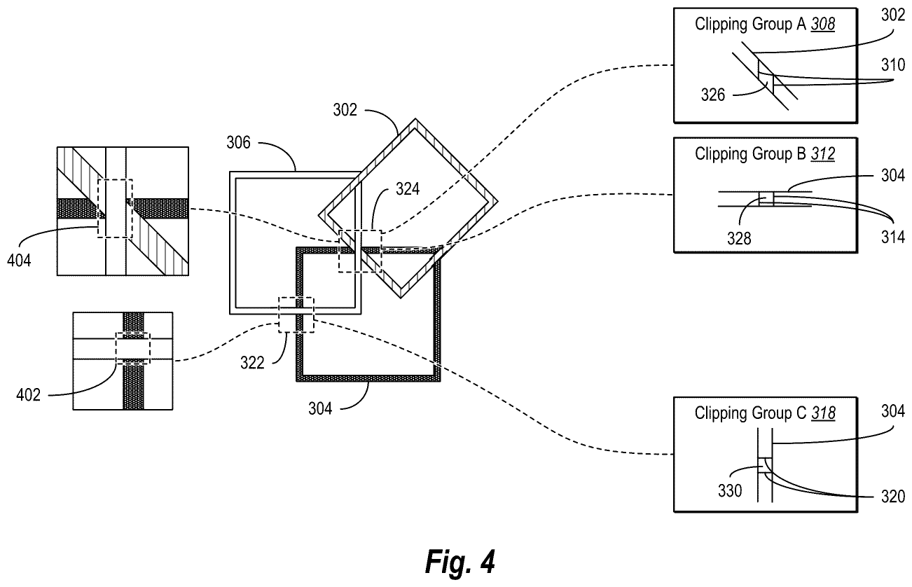

As further illustrated in FIG. 2, in some embodiments, the intertwined object detection system 106 performs an act 206 of determining overlapping zones of the vector objects. Specifically, the intertwined object detection system 106 determines the overlapping zones based on locations of clipping paths (e.g., closed paths) of clipping groups of the vector objects. For instance, in some implementations, the intertwined object detection system 106 generates an overlapping zone for a closed path that does not intersect with other closed paths and/or for a group of intersecting closed paths. Additional detail regarding determining the overlapping zones is provided with respect to FIG. 4.

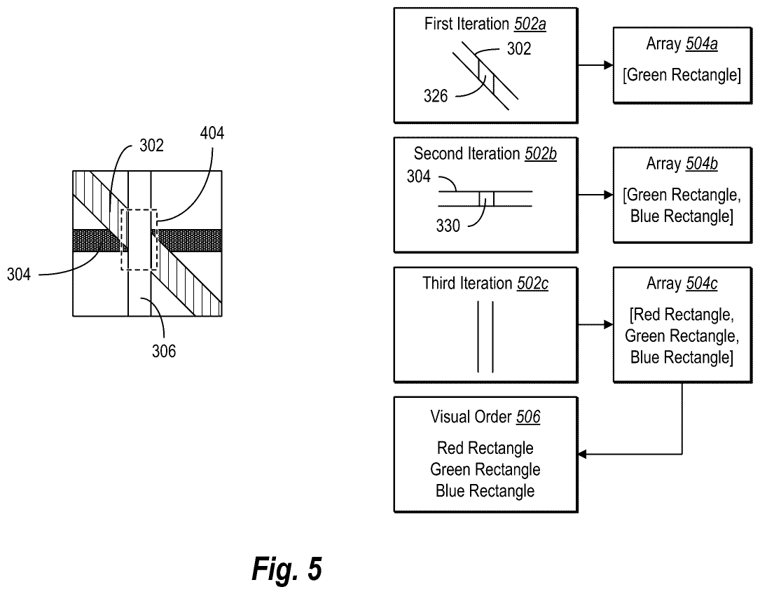

As additionally shown in FIG. 2, in one or more embodiments, the intertwined object detection system 106 performs an act 208 of determining a visual order of the vector objects within the overlapping zones as part of generating a modifiable intertwine group. In particular, the intertwined object detection system 106 determines the visual order of the vector objects for a given zone by iterating through the vector objects in reverse z-order. For instance, the intertwined object detection system 106 adds a vector object to the top of a temporary array to indicate that the vector object is the highest (visually). In these or other embodiments, the intertwined object detection system 106 adds the vector object to the temporary array in response to determining that the vector object is not associated with a closed path within the overlapping zone. Additional detail regarding determining the visual order of vector objects in the overlapping zones is provided with respect to FIG. 5.

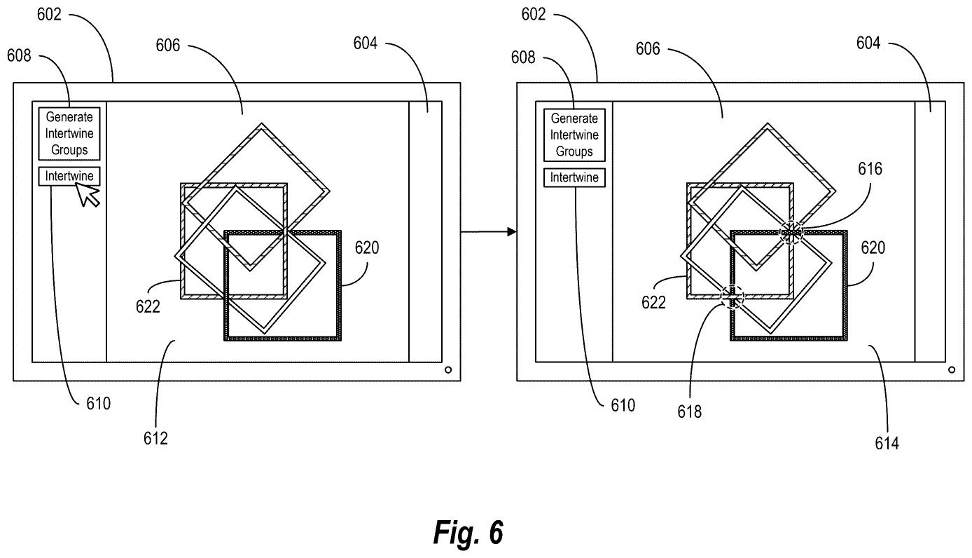

As further illustrated in FIG. 2, in one or more implementations, the intertwined object detection system 106 performs an act 210 of modifying a visual order of the intertwined vector objects and displays the modifications in a graphical user interface of a client device. Specifically, the intertwined object detection system 106 modifies the visual order of the intertwined vector objects within the overlapping zones (e.g., within areas 212 and 214) utilizing the modifiable intertwine groups. For example, in some embodiments, the intertwined object detection system 106 automatically modifies the visual order of the vector objects in response to minimal user interaction (e.g., a single user input) received via the graphical user interface of the client device. Additional detail regarding modifying the visual order of the vector objects in the vector graphic file and displaying the modifications at the client device is provided with respect to FIG. 6.

As previously noted, in some implementations, the intertwined object detection system 106 determines intertwined vector objects. Indeed, in one or more embodiments, the intertwined object detection system 106 determines an intertwined group of vector objects in a vector graphic file. FIG. 3 illustrates a diagram of the intertwined object detection system 106 determining an intertwined group of vector objects in accordance with one or more embodiments.

In one or more implementations, the intertwined object detection system 106 accesses a vector graphic file which includes vector objects. In some embodiments, a vector graphic file includes a digital image file that uses mathematical equations to represent shapes, lines, curves, colors, etc. In particular, in some implementations, a vector graphic file includes digital image files in a plurality of formats including formats specific to digital design applications or in standard formats editable via a plurality of digital design applications. To illustrate, the intertwined object detection system 106 accesses a vector graphic file in a standard file format such as a portable document format (PDF) file, a scalable vector graphics (SVG) file, or an enhanced metafile format (EMF) file.

Additionally, in one or more embodiments, the intertwined object detection system 106 receives a request to create intertwine groups (e.g., modifiable intertwine groups). Specifically, the intertwined object detection system 106 receives a request to create modifiable intertwine groups for intertwining vector objects (e.g., by doing so automatically or in other words without additional user input) within the vector graphic file. For instance, the intertwined object detection system 106 receives the request in response to a user interaction with a graphical user interface of a client device.

To illustrate, the intertwined object detection system 106 receives a request to create modifiable intertwine groups via a graphical user interface of a client device. In particular, the intertwined object detection system 106 receives the request to create the modifiable intertwine groups via a single user interaction, such as via an interactive graphical element of the graphical user interface. In response, the intertwined object detection system 106 automatically determines the intertwine groups included in the document. For example, in one or more implementations, the intertwined object detection system 106 begins determining the intertwine groups by determining vector objects in the vector graphic file.

As shown in FIG. 3, in some embodiments, the intertwined object detection system 106 determines a plurality of vector objects (e.g., a green rectangle 302, a blue rectangle 304, and a red rectangle 306) of the vector graphic file. In some implementations, a vector object includes a graphical element within a vector graphics file defined and rendered. In particular, a vector object is composed of points, paths, lines, curves, and/or shapes. For example, a vector object includes geometric shapes such as rectangles as well as more or less complex shapes.

As mentioned above, in one or more embodiments, the intertwined object detection system 106 determines the vector objects within the vector graphic file. Specifically, the intertwined object detection system 106 determines that the vector graphic file includes an intertwined group of vector objects (also referred to simply as an intertwine group). In one or more implementations, an intertwine group includes a group of two or more intersecting vector objects with a visual order different from a z-order of the vector objects. In particular, an intertwine group includes a group of vector objects that intersect at a location within a vector graphic file and have a visual order at that location that differs from the z-order of the vector objects.

As also depicted in FIG. 3, in some embodiments, the intertwined object detection system 106 determines the intertwine groups by determining that the vector objects include one or more clipping groups. In some implementations, a clipping group includes at least one vector object grouped with at least one clipping path. Specifically, a clipping group includes a clipping object grouped with clipping paths such that the clipping paths form a closed path for masking at least a portion of the vector object in the clipping group. For instance, a clipping group includes clipping paths which form a closed path forming a clipping mask that masks the portion of the vector object of the clipping group within the area of the clipping mask.

Relatedly, in one or more embodiments, a clipping path includes vector-defined boundary that restricts the visible portions of a vector object or group of vector objects within a vector graphic file. In particular, one or more clipping paths form a clipping mask that conceals content within its defined shape and grouped with the clipping path while preserving underlying content (e.g., lower in z-order). For example, a clipping path forms a closed path resulting in a clipping mask in a square, rhombus, circle, or other shape used to mask the corresponding portion of a vector object allowing an additional vector object to be visible.

To illustrate, the intertwined object detection system 106 determines that the green rectangle 302, the blue rectangle 304, and the red rectangle 306 include three clipping groups. In particular, the intertwined object detection system 106 determines that the vector graphic file includes three clipping groups associated with the green rectangle 302, the blue rectangle 304, and the red rectangle 306. For example, the intertwined object detection system 106 determines clipping group A 308 including the green rectangle 302 and the clipping paths 310. Further, the intertwined object detection system 106 determines clipping group B 312 including the blue rectangle 304 and the clipping paths 314 and the clipping group C 318 including the blue rectangle 304 and the clipping paths 320.

As further illustrated in FIG. 3, in one or more implementations, the intertwined object detection system 106 determine the intertwine groups based on relative locations of the clipping groups. Specifically, the intertwined object detection system 106 iterates through the vector objects in reverse z-order to determine the relative locations of the clipping groups. For example, the intertwined object detection system 106 determines whether clipping groups are spatially mutually exclusive or intersecting.

To illustrate, the intertwined object detection system 106 begins with the highest (i.e., last in z-order) vector object to determine the location of clipping groups associated therewith. In this example, the z-order of the objects includes the red rectangle 306 as the lowest or first, the blue rectangle 304 above the red rectangle 306 but below the green rectangle 302, and the green rectangle 302 as the highest or last. Thus, in this example, the intertwined object detection system 106 begins with the green rectangle 302 to determine the location of clipping groups (e.g., clipping group A 308) associated therewith. More specifically, the intertwined object detection system 106 determines the location of a closed path forming a clipping mask of the clipping group A 308. For example, the intertwined object detection system 106 determines that the clipping paths 310, along with paths of the green rectangle 302, form a closed path 326 forming a rhombus shaped clipping mask (also referred to herein as a rhombus closed path 326) for masking the corresponding portion of the green rectangle 302.

To further illustrate, the intertwined object detection system 106 continues with the next highest vector object in z-order, the blue rectangle 304. Indeed, the intertwined object detection system 106 similarly determines the location of a closed path 328 forming a square shaped clipping mask (also referred to herein as a first square closed path 328) and formed by the clipping paths 314 and paths of the blue rectangle 304 of clipping group B 312. Moreover, the location of a second closed path 330 forming a square shaped clipping mask (also referred to herein as a second square closed path 330) formed by the clipping paths 320 and paths of the blue rectangle 304 of clipping group C 318. Finally, the intertwined object detection system 106 continues with the lowest vector object in z-order, the red rectangle 306, and determines that there are no clipping groups associated with the red rectangle 306.

As noted above, the intertwined object detection system 106 determines whether the clipping groups are spatially mutually exclusive or intersecting. To illustrate, the intertwined object detection system 106 determines that the second square closed path 330 formed by the clipping paths 320 and the paths of the blue rectangle 304 is mutually exclusive from either of the other identified closed paths. In other words, the second square closed path 330 of the clipping group C 318 does not intersect with any other closed path of any other clipping group.

In some embodiments, based on determining that the second square closed path 330 of the clipping group C 318 does not intersect with any other closed path, the intertwined object detection system 106 determines the intertwine group 322.

To further illustrate, the intertwined object detection system 106 determines that the rhombus closed path 326 for masking a portion of the green rectangle 302 intersects with the first square closed path 328 for masking a portion of the blue rectangle 304. In other words, the intertwined object detection system 106 identifies a union of clipping path boundaries formed by the rhombus closed path 326 and the square closed path.

Based on determining the union of the clipping path boundaries, the intertwined object detection system 106 further determines whether a non-clipping path object intersects with a union of clipping path boundaries. In some implementations, a non-clipping path object includes a vector object or a portion of a vector object within an area of the vector graphic file that does not include a clipping path.

To illustrate, the intertwined object detection system 106 determines that a portion of the red rectangle 306 forms a non-clipping path object 316. Further, the intertwined object detection system 106 determines that the non-clipping path object 316 intersects with the union of the clipping path boundaries of the clipping group A 308 and the clipping group B 312. In particular, the intertwined object detection system 106 determines that the non-clipping path object 316 intersects with the union of the rhombus closed path 326 and the first square closed path 328. Based on determining this intersection of the non-clipping path object 316 with the union of the clipping paths, the intertwined object detection system 106 determines the intertwine group 324.

As mentioned previously, in one or more embodiments, the intertwined object detection system 106 determines overlapping zones of vector objects. Indeed, in one or more implementations, the intertwined object detection system 106 determines and generates overlapping zones of the vector objects as part of generating the modifiable intertwine groups. FIG. 4 illustrates a diagram of the intertwined object detection system 106 determining overlapping zones of intertwining vector objects in accordance with one or more embodiments.

As portrayed in FIG. 4, in some embodiments, the intertwined object detection system 106 determines a first overlapping zone 402 and a second overlapping zone 404 by comparing locations of closed paths of the intertwining vector objects. In some implementations, the intertwined object detection system 106 utilizes the first overlapping zone 402 and the second overlapping zone 404 as areas of the vector graphic file in which the intertwined object detection system 106 generates modifiable intertwine groups. Indeed, the intertwined object detection system 106 generates the overlapping zones, determines the visual order of the vector objects within the zones, and generates the modifiable intertwine groups based on the boundaries of the overlapping zones.

As noted previously, the intertwined object detection system 106 determines the first overlapping zone 402 and the second overlapping zone 404 by comparing the locations of the closed paths of the intertwining objects. Specifically, the intertwined object detection system 106 determines the first overlapping zone 402 and the second overlapping zone 404 by comparing the locations of the closed paths of the clipping groups (e.g., clipping group A 308, clipping group B 312, and clipping group C 318). As discussed above with respect to FIG. 3, in one or more embodiments, the intertwined object detection system 106 determines the locations of the rhombus closed path 326 of clipping group A 308, the first square closed path 328 of clipping group B 312, and the second square closed path 330 of clipping group C 318.

To illustrate, the intertwined object detection system 106 compares the locations of the rhombus closed path 326 of the clipping group A 308, the first square closed path 328 of the clipping group B 312, and the second square closed path 330 of the clipping group C 318. In these or other embodiments, the intertwined object detection system 106 determines that the second square closed path 330 of the clipping group C 318 does not intersect with either of the other closed paths. In one or more implementations, based on determining that the second square closed path 330 of the clipping group C 318 does not intersect with any other closed path of the clipping groups in the vector graphic file, the intertwined object detection system 106 determines the first overlapping zone 402.

Furthermore, in some embodiments, the intertwined object detection system 106 generates the first overlapping zone 402 based on the boundaries of the second square closed path 330 of the clipping group C 318. Indeed, the intertwined object detection system 106 generates the first overlapping zone 402 to match the boundaries of the second square closed path 330 of the clipping group C 318.

To further illustrate, the intertwined object detection system 106 determines that the rhombus closed path 326 of the clipping group A 308 intersects with the first square closed path 328 of the clipping group B 312 within the intertwine group 324. For example, the intertwined object detection system 106 determines that the rhombus closed path 326 and the first square closed path 328 intersect in the x-y plane in the intertwine group 324 to mask the green rectangle 302 and the blue rectangle 304, respectively. This intersection of the closed paths and masking of the green rectangle 302 and blue rectangle 304 allows the red rectangle 306 to be visually highest in the intertwine group 324.

In this case, the intertwined object detection system 106 determines the second overlapping zone 404 based on the boundaries of both the rhombus closed path 326 and the first square closed path 328. Additionally, in this example, the intertwined object detection system 106 generates the second overlapping zone 404 to match a unified boundary of the rhombus closed path 326 and the first square closed path 328. Indeed, in these or other embodiments, the intertwined object detection system 106 generates the second overlapping zone 404 to completely encompass the boundaries of both the rhombus closed path 326 and the first square closed path 328.

Further, in some implementations, the intertwined object detection system 106 determines and generates the overlapping zones by iterating through the vector objects of the vector graphic file in reverse z-order. To illustrate, the intertwined object detection system 106 begins by determining and generating an overlapping zone corresponding to the rhombus closed path 326 of clipping group A 308 because it is associated with the highest vector object, the green rectangle 302. Moreover, the intertwined object detection system 106 continues with the blue rectangle 304 and determines that the first square closed path 328 of the clipping group B 312 intersections with the rhombus closed path 326 of the clipping group A 408. Furthermore, the intertwined object detection system 106 determines an updated clipping group based on the combined boundaries of the rhombus closed path 326 and the first square closed path 328 and generates an updated overlapping zone (e.g., the second overlapping zone 404).

To further illustrate, the intertwined object detection system 106 continues with the blue rectangle 304 and determines that the second square closed path 330 of the clipping group C 318 does not intersect with any other closed path. Based on determining that the second square closed path 330 of the clipping group C 318 does not intersect with any other closed path, the intertwined object detection system 106 determines and generates an additional overlapping zone (e.g., the first overlapping zone 402). Finally, the intertwined object detection system 106 continues with the red rectangle 306 and determines that the red rectangle 306 does not include any clipping group with a closed path.

In one or more embodiments, the intertwined object detection system 106 utilizes an algorithm to determine and generate the first overlapping zone 402 and the second overlapping zone 404. For instance, the intertwined object detection system 106 determines and generates the first overlapping zone 402 and the second overlapping zone 404 utilizing Algorithm 1:

Algorithm 1 GetZones (input render tree T)

| | |
|---|---|
| 1: | Zones ← Ø |
| 2: | for Art in reverse Z-order of T do |
| 3: | if (Art is Clipping group) then |
| 4: | Fetch closed paths P for Art |
| 5: | for each path Pᵢ in P do |
| 6: | if (Zones == Ø or Zones ∩ Pi = Ø) then |
| 7: | Zones ← Zones + Pᵢ |
| 8: | else |
| 9: | for each Zᵢ in Zones do |
| 10: | if (Zᵢ ∩ Pᵢ != Ø) then |
| 11: | Zᵢ ← Zᵢ ∪ Pᵢ |
| 12: | return Zones |

As previously mentioned, in one or more implementations, the intertwined object detection system 106 determines a visual order of vector objects within the overlapping zones. Indeed, in some embodiments, the intertwined object detection system 106 determines the visual order of intertwining vector objects within the overlapping zones as part of generating modifiable intertwine groups. FIG. 5 illustrates a diagram of the intertwined object detection system 106 determining a visual order of intertwining vector objects within overlapping zones in accordance with one or more embodiments.

As depicted in FIG. 5, in some implementations, the intertwined object detection system 106 determines a visual order 506 of vector objects within each of the overlapping zones. In particular, FIG. 5 shows the intertwined object detection system 106 determining the visual order 506 of the green rectangle 302, the blue rectangle 304, and the red rectangle 306 within the second overlapping zone 404. For example, the intertwined object detection system 106 determines the visual order 506 by iterating in reverse z-order through the intertwining green rectangle 302, blue rectangle 304, and red rectangle 306 vector objects. As previously noted, in this example, the z-order of the vector objects includes the red rectangle 306 as lowest, followed by the blue rectangle 304, followed by the green rectangle 302 as highest.

As additionally shown in FIG. 5, in one or more embodiments, the intertwined object detection system 106 iterates through the vector objects in reverse z-order to determine the visually highest vector object. Specifically, the intertwined object detection system 106 determines the visually highest vector object by comparing the locations of the closed paths of the clipping groups with the locations of the overlapping zones. To illustrate, the intertwined object detection system 106 performs an iteration of comparing the locations of the closed paths of the clipping group groups for each of the green rectangle 302, the blue rectangle 304, and the red rectangle 306 in reverse z-order and generating a temporary array.

In this illustration, in the first iteration 502a the intertwined object detection system 106 determines that the location of the rhombus closed path 326 of the clipping group A of the green rectangle 302 intersects with the second overlapping zone 404. Based on this intersection and the green rectangle 302 belonging to the clipping group A 308, the intertwined object detection system 106 generates the temporary array (e.g., array 504a) and adds the green rectangle to the array 504a. Similarly, in the second iteration 502b, the intertwined object detection system 106 determines that the first square closed path 328 of the blue rectangle 304 also intersects with the second overlapping zone 404. Based on this intersection and the blue rectangle 304 belonging to the clipping group B 312, the intertwined object detection system 106 adds the blue rectangle 304 to the array 504b.

As further illustrated in FIG. 5, in the third iteration 502c, the intertwined object detection system 106 determines that there is no closed path of a clipping group associated with the red rectangle 306 within the second overlapping zone 404. In other words, the red rectangle 306 does not belong to a clipping group in the second overlapping zone 404. Accordingly, the intertwined object detection system 106 adds the red rectangle 306 to the top position of the array 504c in the third iteration 502c. Indeed, the intertwined object detection system 106 adds the visually highest object, the red rectangle 306, to the top position of the array 504c.

Additionally, in one or more implementations, the intertwined object detection system 106 determines the visual order 506 of the vector objects based on the array 504c. In particular, the intertwined object detection system 106 determines the visual order 506 of the green rectangle 302, the blue rectangle 304, and the red rectangle 306 based on the array 504c after the final iteration. For example, the intertwined object detection system 106 terminates the act of iterating through the vector objects within an overlapping zone after determining that one of the vector objects within the boundaries of the overlapping zone does not include a closed path intersecting with the boundaries of the overlapping zone. In these or other embodiments, after the final iteration, the intertwined object detection system 106 determines the visual order 506 of the vector objects within the zone based on the order of the vector objects within the temporary array.

In some embodiments, the intertwined object detection system 106 utilizes an algorithm to determine the visual order within each overlapping zone. For example, the intertwined object detection system 106 determines the visual order 506 for the second overlapping zone 404 utilizing Algorithm 2:

Algorithm 2 GetVisualOrder (Input Zone Z, Input render tree T)

| | |
|---|---|
| 1: | VisualOrder ← Ø, TempArray ← Ø |
| 2: | for Art in reverse Z-order of T do |
| 3: | if (Art is Clipping group) then |
| 4: | Fetch closed paths P for art |
| 5: | for each path Pᵢ in P do |
| 6: | if (Pᵢ ∩ Z) then |
| 7: | TempArray ← TempArray + Art |
| 8: | else |
| 9: | VisualOrder ← VisualOrder + Art |
| 10: | VisualOrder ← VisualOrder + ContentsOf(TempArray) |
| 11: | TempArray ← Ø |
| 12: | else |
| 13: | VisualOrder ← VisualOrder + Art |
| 14: | VisualOrder ← VisualOrder + ContentsOf(TempArray) |
| 15: | TempArray ← Ø |
| 16: | return VisualOrder |

Further, in some implementations, the intertwined object detection system 106 generates a modifiable intertwine group corresponding to each overlapping zone. Specifically, the intertwined object detection system 106 generates the modifiable intertwine groups to include the metadata and relationships of the vector objects within each overlapping zone. For example, for each overlapping zone, the intertwined object detection system 106 generates a modifiable intertwine group including the metadata and relationships (e.g., z-order, visual order, etc.) of each of the clipping groups and/or vector objects within the overlapping zone. Indeed, in these or other embodiments, the intertwined object detection system 106 generates the modifiable intertwine groups to enable an act of modifying the visual order thereof to generate a modified intertwining appearance of the vector objects in the vector graphic file.

As mentioned above, in one or more embodiments, the intertwined object detection system 106 modifies a visual order of the intertwined vector objects. In particular, the intertwined object detection system 106 modifies the visual order of the intertwined vector objects for display in a graphical user interface of a client device. FIG. 6 illustrates an example graphical user interface that the intertwined object detection system 106 uses to modify the visual order of intertwined vector objects in accordance with one or more embodiments.

As illustrated in FIG. 6, in one or more implementations, the intertwined object detection system 106 generates a graphical user interface 604 for display on a client device 602. Moreover, in some embodiments, the intertwined object detection system 106 accesses a vector graphic file 606 for display within the graphical user interface 604. Furthermore, in some implementations, the intertwined object detection system 106 generates modifiable intertwine groups in response to user input via a group interactive element 608. Specifically, the intertwined object detection system 106 automatically detects and generates the modifiable intertwine groups in response to a single user interaction with the group interactive element 608.

As also depicted in FIG. 6, in one or more embodiments, the intertwined object detection system 106 modifies the visual order of the intertwining vector objects of the vector graphic file 606. In particular, the intertwined object detection system 106 modifies the visual order of the intertwining vector objects in response to a user input. For example, the intertwined object detection system 106 receives a user input (e.g., a single user interaction) via an intertwine interactive element 610 and modifies the visual order of the vector objects in the vector graphic file.

To illustrate, the vector objects (i.e., the colored rectangles) in the vector graphic file 606 are arranged in an intertwining design 612. Additionally, in response to the user input via the intertwine interactive element 610, the intertwined object detection system 106 generates a modified intertwining design 614 utilizing the modifiable intertwine groups. Indeed, in this example, the intertwined object detection system 106 modifies the intertwining design 612 such that the colored rectangle vector objects in the modified intertwining design 614 have a modified visual order within the areas 616 and 618. For example, the visually highest vector object in the area 616 is modified to the blue rectangle 620 from the red rectangle 622. Further, the visually highest vector object in the area 618 is modified to the red rectangle 622 from the blue rectangle 620.

In these or other embodiments, the intertwined object detection system 106 modifies the visual order of the colored rectangles in the areas 616 and 618 within the overlapping zones of the modifiable intertwine groups. Indeed, the intertwined object detection system 106 does so by changing the visually highest vector objects within the respective overlapping zones. In this manner the intertwined object detection system 106 displays the modified intertwining design 614 in the graphical user interface 604.

In one or more implementations, the intertwined object detection system 106 detects the intertwine groups, generates the modifiable intertwine groups, and modifies the visual order of the intertwining vector objects in response to a single user input. For instance, the intertwined object detection system 106 generates the graphical user interface 604 to include the intertwine interactive element 610 but not the group interactive element 608. Further, in these or other embodiments, in response to a single user interaction with the intertwine interactive element 610, the intertwined object detection system 106 automatically generates the modified intertwining design 614. Indeed, the intertwined object detection system 106 automatically detects the intertwine groups, generates the modifiable intertwine groups, and utilizes the modifiable intertwine groups to modify the visual order of the colored rectangles, thereby automatically generating the modified intertwining design 614.

Turning to FIG. 7, additional detail will now be provided regarding various components and capabilities of the intertwined object detection system 106. In particular, FIG. 7 illustrates an example schematic diagram of a computing device 700 (e.g., the server device(s) 102 and/or the client device(s) 110) implementing the intertwined object detection system 106 in accordance with one or more embodiments of the present disclosure for components 700-708. As illustrated in FIG. 7, the intertwined object detection system 106 includes a vector object manager 702, an overlapping zone manager 704, a visual order manager 706, and a storage manager 708.

The vector object manager 702 accesses a vector graphic file and receives a request to create intertwine groups for intertwining vector objects within a vector graphic file. Moreover, the vector object manager 702 determines that the vector objects include intertwine groups of vector objects. Specifically, the vector object manager 702 determines the intertwine groups based on the relative locations of clipping groups of the vector objects. For example, vector object manager 702 determines or identifies clipping groups and determines the intertwine groups by determining that a clipping group is mutually exclusive in location from other clipping groups or that a non-clipping path object intersects with a union (e.g., intersection) of clipping path boundaries of the clipping groups.

Furthermore, the overlapping zone manager 704 determines and generates overlapping zones as part of generating modifiable intertwine groups. In particular, the overlapping zone manager 704 determines and generates the overlapping zones by comparing locations of the closed paths of clipping groups of intertwining vector objects. For instance, the overlapping zone manager 704 generates an overlapping zone by comparing locations of closed paths of the intertwining vector objects. To illustrate, the overlapping zone manager 704 generates an overlapping zone based on determining that a closed path of a clipping group of a vector object does not overlap with another closed path of a different clipping group. Additionally, or alternatively, the overlapping zone manager 704 generates an overlapping zone when two closed paths of different clipping zones intersect.

Additionally, the visual order manager 706 determines a visual order of intertwining vector objects within an overlapping zone. Further, the visual order manager 706 receives a user input to modify the visual order of the intertwining vector objects within a zone such as via a graphical user interface of a client device. Moreover, the visual order manager 706 modifies the visual order of the intertwining vector objects within an overlapping zone by changing the visually highest vector object within the overlapping zone.

Furthermore, as shown in FIG. 7, the intertwined object detection system 106 includes a storage manager 708. In one or more implementations, the storage manager 708 stores information (e.g., via one or more memory devices) on behalf of the intertwined object detection system 106. For example, the storage manager 708 includes a database for storing clipping paths, closed paths, clipping groups, vector objects, overlapping zones, locations of clipping paths and overlapping zones, and/or modifiable intertwine groups.

In some embodiments, each of the components 702-708 of the intertwined object detection system 106 include software, hardware, or both. For example, the components 702-708 include one or more instructions stored on a computer-readable storage medium and executable by processors of one or more computing devices, such as a client device or server device. When executed by the one or more processors, the computer-executable instructions of the intertwined object detection system 106 cause the computing device(s) to perform the methods described herein. Alternatively, the components 702-708 include hardware, such as a special-purpose processing device to perform a certain function or group of functions. Alternatively, the components 702-708 of the intertwined object detection system 106 include a combination of computer-executable instructions and hardware.

Furthermore, the components 702-708 of the intertwined object detection system 106 are, for example, implemented as one or more operating systems, as one or more stand-alone applications, as one or more modules of an application, as one or more plug-ins, as one or more library functions or functions that may be called by other applications, and/or as a cloud-computing model. Thus, in various embodiments, the components 702-708 of the intertwined object detection system 106 are implemented as a stand-alone application, such as a desktop or mobile application. Furthermore, in various embodiments, the components 702-708 of the intertwined object detection system 106 are implemented as one or more web-based applications hosted on a remote server. Alternatively, or additionally, the components 702-708 of the intertwined object detection system 106 are implemented in a suite of mobile device applications or “apps.” For example, in one or more embodiments, the intertwined object detection system 106 comprises or operates in connection with digital software applications such as ADOBE® EXPRESS®, ADOBE® ILLUSTRATOR® CREATIVE CLOUD®, ADOBE® INDESIGN® CREATIVE CLOUD®, and/or ADOBE® PHOTOSHOP® CREATIVE CLOUD®.

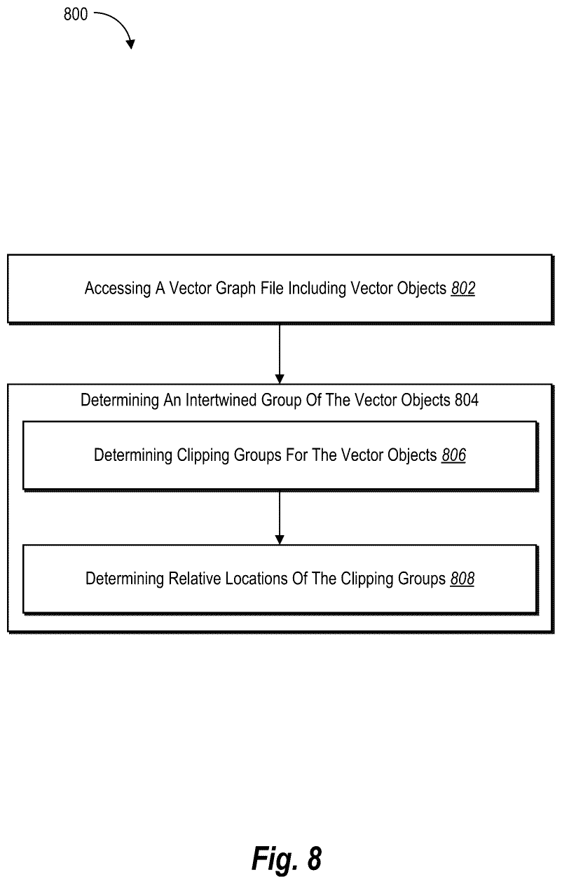

FIGS. 1-7, the corresponding text, and the examples provide a number of different systems, methods, and non-transitory computer readable media for detecting and generating modifiable intertwine groups of intertwining vector objects in vector-based designs of vector graphic files. In addition to the foregoing, embodiments can also be described in terms of flowcharts comprising acts for accomplishing a particular result. For example, FIGS. 8-10 illustrate flowcharts of example sequences of acts in accordance with one or more embodiments.

While FIGS. 8-10 illustrate acts according to some embodiments, alternative embodiments may omit, add to, reorder, and/or modify any of the acts shown in FIGS. 8-10. The acts of FIGS. 8-10 are performed as part of a method. Alternatively, a non-transitory computer readable medium comprises instructions, that when executed by one or more processors, cause a computing device to perform the acts of FIGS. 8-10. In still further embodiments, a system performs the acts of FIGS. 8-10. Additionally, the acts described herein may be repeated or performed in parallel with one another or in parallel with different instances of the same or other similar acts.

FIG. 8 illustrates an example series of acts 800 for determining an intertwined group of vector objects in a vector graphic file. The series of acts 800 includes an act 802 of accessing a vector graph file including vector objects; an act 804 of determining an intertwined group of the vector objects; an act 806 of determining clipping groups for the vector objects; and an act 808 of determining relative locations of the clipping groups.

In some embodiments, the act 802 includes accessing a vector graphic file including a plurality of vector objects. In some embodiments, the act 804 also includes an act of determining, by at least one processor, that the plurality of vector objects includes an intertwined group of vector objects by determining that the plurality of vector objects include one or more clipping groups. In some implementations, the act 808 further includes an act of determining that the one or more clipping groups are spatially mutually exclusive or a non-clipping path object intersects with a union of clipping path boundaries of the one or more clipping groups.

In some implementations, determining that the plurality of vector objects include the one or more clipping groups includes iterating through the plurality of vector objects in reverse z-order to determine an intersection between a clipping path and an additional non-clipping path object.

In one or more embodiments, determining that the non-clipping path object intersects with the union of clipping path boundaries within the one or more clipping groups includes determining the union of clipping path boundaries by determining that a first clipping path of a first clipping group of the one or more clipping groups intersects with a second clipping path of a second clipping group of the one or more clipping groups.

In one or more implementations, the series of acts 800 includes determining one or more overlapping zones of the plurality of vector objects by comparing locations of closed paths of the one or more clipping groups of the plurality of vector objects.

In some embodiments, determining the one or more overlapping zones of the plurality of vector objects by comparing the locations of the closed paths of the one or more clipping groups includes determining a first closed path including clipping paths of a first clipping group. Additionally, in one or more embodiments, the series of acts 800 includes an act of determining a second closed path including clipping paths of a second clipping group. In one or more implementations, the series of acts 800 also includes an act of comparing a first location of the first closed path with a second location of the second closed path.

In some implementations, the series of acts 800 includes determining a visual order of the plurality of vector objects within each of the one or more overlapping zones.

In one or more embodiments, the series of acts 800 includes modifying, based on a user input, a visual order of the plurality of vector objects within an overlapping zone of the plurality of vector objects by changing a highest vector object within the overlapping zone.

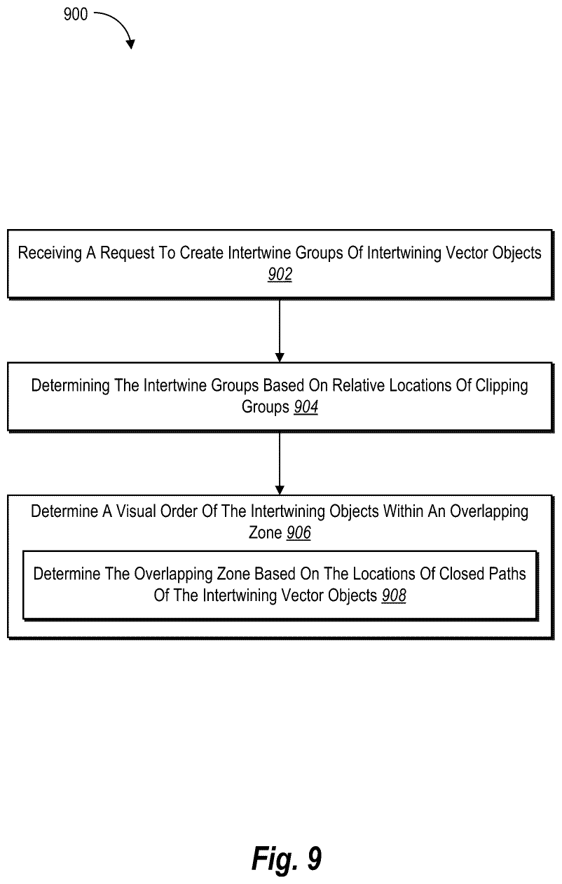

FIG. 9 illustrates an example series of acts 900 for determining a visual order of intertwining objects within a vector graphic file. The series of acts 900 includes an act 902 of receiving a request to create intertwine groups of intertwining vector objects; an act 904 of determining the intertwine groups based on relative locations of clipping groups; an act 906 of determine a visual order of the intertwining objects within an overlapping zone; and an act 908 of determine the overlapping zone based on the locations of closed paths of the intertwining vector objects.

In one or more implementations, the act 902 includes receiving a request to create intertwine groups for intertwining vector objects within a vector graphic file. In some embodiments, the act 904 further includes an act of determining, from the vector graphic file, one or more intertwine groups based on relative locations of clipping groups of vector objects in the vector graphic file. Additionally, in some implementations, the act 908 includes an act of determining one or more overlapping zones of the intertwining vector objects by comparing locations of closed paths of the intertwining vector objects. In one or more embodiments, the act 906 also includes an act of determining a visual order of the intertwining vector objects within each of the one or more overlapping zones.

In some embodiments, the series of acts 900 includes determining the one or more intertwine groups based on the relative locations of the clipping groups of the vector objects in the vector graphic file by determining a first intertwine group of the one or more intertwine groups based on determining that a first clipping path of a first clipping group of the clipping groups does not intersect with a second clipping path of a second clipping group of the vector objects. In one or more implementations, the series of acts 900 further includes an act of or determining the first intertwine group of the one or more intertwine groups based on determining that a non-clipping path object intersects with a union of the first clipping path of the first clipping group and the second clipping path of the second clipping group.

In some implementations, the series of acts 900 includes determining the one or more overlapping zones between the intertwining vector objects by comparing the locations of the closed paths of the intertwining vector objects by determining that a first closed path and a second closed path of the closed paths of the intertwining vector objects intersect. Additionally, in some embodiments, the series of acts 900 includes an act of determining a first overlapping zone based on the first closed path and the second closed path.

In one or more embodiments, the series of acts 900 includes determining the one or more overlapping zones between the intertwining vector objects by comparing the locations of the closed paths of the intertwining vector objects by determining that a first closed path and a second closed path of the closed paths of the intertwining vector objects do not intersect. In some implementations, the series of acts 900 also includes an act of determining a first overlapping zone based on the first closed path. In one or more embodiments, the series of acts 900 further includes an act of determining a second overlapping zone based on the second closed path.

In one or more implementations, the series of acts 900 includes determining the visual order of the intertwining vector objects within each of the one or more overlapping zones by comparing the locations of the closed paths of the intertwining vector objects with locations of the one or more overlapping zones of the intertwining vectors objects.

In some embodiments, the series of acts 900 includes determining the visual order of the intertwining vector objects within each of the one or more overlapping zones by iterating through the intertwining vector objects in reverse z-order.

In some implementations, the series of acts 900 includes generating a temporary array. Additionally, in one or more implementations, the series of acts 900 includes an act of adding a highest object of the intertwining vector objects to a top position of the temporary array based on iterating through the intertwining vector objects in reverse z-order.

FIG. 10 illustrates an example series of acts 1000 for modifying a visual order of intertwining vector objects within a vector graphic file. The series of acts 1000 include an act 1002 of determine intertwine groups of intertwining objects based on relative locations of clipping groups of vector objects; an act 1004 of determine overlapping zones between the intertwining vector objects of a vector graphic file based on closed paths; an act 1006 of modifying the visual order of the intertwining vector objects within the overlapping zones; an act 1008 of determine a visual order of the intertwining vector objects within the overlapping zones; and an act 1010 of receiving a user input to modify the visual order of the intertwining vector objects.

In one or more embodiments, the act 1002 includes determining, from a vector graphic file, one or more intertwine groups based on relative locations of clipping groups of vector objects in the vector graphic file. In some embodiments, the act 1004 also includes an act of determining one or more overlapping zones between intertwining vector objects of the vector graphic file by comparing locations of closed paths of the intertwining vector objects. In some implementations, the act 1008 further includes an act of determining a visual order of the intertwining vector objects within each of the one or more overlapping zones. Additionally, in one or more embodiments, the act 1006 includes an act of receiving a user input to modify the visual order of the intertwining vector objects within a first overlapping zone of the one or more overlapping zones. In one or more implementations, the act 1006 also includes an act of modifying the visual order of the intertwining vector objects within the first overlapping zone by changing a highest vector object within the first overlapping zone without further user input.

In one or more implementations, the series of acts 1000 includes receiving, in response to user interaction with a graphical user interface of a client device, a request to create a modifiable intertwine group for intertwining the vector objects within the vector graphic file.

In some embodiments, determining the visual order of the intertwining vector objects within each of the one or more overlapping zones includes iterating through the intertwining vector objects in reverse z-order to determine the highest vector object of the intertwining vector objects.

In some implementations, the series of acts 1000 includes generating a temporary array. In some embodiments, the series of acts 1000 further includes an act of determining a first closed path of a first clipping group of the clipping groups of the vector objects. Additionally, in some implementations, the series of acts 1000 includes an act of adding a first vector object of the intertwining vector objects based on the first vector object belonging to the first clipping group.

In one or more embodiments, the series of acts 1000 includes determining a second vector object of the intertwining vector objects based on determining that the second object does not belong to the clipping groups. In one or more embodiments, the series of acts 1000 also includes an act of adding the second vector object to a top position of the temporary array.

In one or more implementations, modifying the visual order of the intertwining vector objects within the first overlapping zone by changing the highest vector object within the first overlapping zone without further user input includes displaying, in a graphical user interface of a client device, the first vector object above the second vector object.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 11 illustrates, in block diagram form, an example computing device 1100 (e.g., the computing device 700, the client device(s) 110, and/or the server device(s) 102) that may be configured to perform one or more of the processes described above. As shown by FIG. 11, the computing device can comprise a processor(s) 1102, memory 1104, a storage device 1106, an I/O interface 1108, and a communication interface 1110.

In particular embodiments, processor(s) 1102 includes hardware for executing instructions, such as those making up a computer program. As an example, and not by way of limitation, to execute instructions, processor(s) 1102 may retrieve (or fetch) the instructions from an internal register, an internal cache, memory 1104, or a storage device 1106 and decode and execute them. The computing device 1100 includes memory 1104, which is coupled to the processor(s) 1102. The memory 1104 may be used for storing data, metadata, and programs for execution by the processor(s). The memory 1104 may include one or more of volatile and non-volatile memories. The memory 1104 may be internal or distributed memory. The computing device 1100 includes a storage device 1106 includes storage for storing data or instructions. As an example, and not by way of limitation, storage device 1106 can comprise a non-transitory storage medium described above. The computing device 1100 also includes one or more input or output (“I/O”) devices/interfaces 1108, which are provided to allow a user to provide input to (such as user strokes), receive output from, and otherwise transfer data to and from the computing device 1100. These I/O devices/interfaces 1108 may include a mouse, keypad or a keyboard, a touch screen, camera, optical scanner, network interface, modem, other known I/O devices or a combination of such I/O devices/interfaces 1108.

The computing device 1100 can further include a communication interface 1110. The communication interface 1110 can include hardware, software, or both. The communication interface 1110 can provide one or more interfaces for communication (such as, for example, packet-based communication) between the computing device and one or more other computing devices (e.g., computing device 1100) or one or more networks. The computing device 1100 can further include a bus 1112. The bus 1112 can comprise hardware, software, or both that couples components of computing device 1100 to each other.

What is claimed is:

1. A computer-implemented method comprising:
accessing a vector graphic file comprising a plurality of vector objects;
determining, by at least one processor, that the plurality of vector objects comprises an intertwined group of vector objects by:
determining that the plurality of vector objects comprise one or more clipping groups; and
determining that the one or more clipping groups are spatially mutually exclusive or a non-clipping path object intersects with a union of clipping path boundaries of the one or more clipping groups.

2. The computer-implemented method of claim 1, wherein determining that the plurality of vector objects comprise the one or more clipping groups comprises iterating through the plurality of vector objects in reverse z-order to determine an intersection between a clipping path and an additional non-clipping path object.

3. The computer-implemented method of claim 1, wherein determining that the non-clipping path object intersects with the union of clipping path boundaries within the one or more clipping groups comprises determining the union of clipping path boundaries by determining that a first clipping path of a first clipping group of the one or more clipping groups intersects with a second clipping path of a second clipping group of the one or more clipping groups.

4. The computer-implemented method of claim 1, further comprising determining one or more overlapping zones of the plurality of vector objects by comparing locations of closed paths of the one or more clipping groups of the plurality of vector objects.

5. The computer-implemented method of claim 4, wherein determining the one or more overlapping zones of the plurality of vector objects by comparing the locations of the closed paths of the one or more clipping groups comprises:
determining a first closed path comprising clipping paths of a first clipping group;
determining a second closed path comprising clipping paths of a second clipping group; and
comparing a first location of the first closed path with a second location of the second closed path.

6. The computer-implemented method of claim 5, further comprising determining a visual order of the plurality of vector objects within each of the one or more overlapping zones.

7. The computer-implemented method of claim 1, further comprising modifying, based on a user input, a visual order of the plurality of vector objects within an overlapping zone of the plurality of vector objects by changing a highest vector object within the overlapping zone.

8. A system comprising:
one or more memory devices; and
one or more processing devices configured to cause the system to:
receive a request to create intertwine groups for intertwining vector objects within a vector graphic file;
determine, from the vector graphic file, one or more intertwine groups based on relative locations of clipping groups of vector objects in the vector graphic file;
determine one or more overlapping zones of the intertwining vector objects by comparing locations of closed paths of the intertwining vector objects; and
determine a visual order of the intertwining vector objects within each of the one or more overlapping zones.

9. The system of claim 8, wherein the one or more processing devices are further configured to determine the one or more intertwine groups based on the relative locations of the clipping groups of the vector objects in the vector graphic file by:
determining a first intertwine group of the one or more intertwine groups based on determining that a first clipping path of a first clipping group of the clipping groups does not intersect with a second clipping path of a second clipping group of the vector objects; or
determining the first intertwine group of the one or more intertwine groups based on determining that a non-clipping path object intersects with a union of the first clipping path of the first clipping group and the second clipping path of the second clipping group.

10. The system of claim 8, wherein the one or more processing devices are further configured to determine the one or more overlapping zones between the intertwining vector objects by comparing the locations of the closed paths of the intertwining vector objects by:
determining that a first closed path and a second closed path of the closed paths of the intertwining vector objects intersect; and
determining a first overlapping zone based on the first closed path and the second closed path.

11. The system of claim 8, wherein the one or more processing devices are further configured to determine the one or more overlapping zones between the intertwining vector objects by comparing the locations of the closed paths of the intertwining vector objects by:
determining that a first closed path and a second closed path of the closed paths of the intertwining vector objects do not intersect;
determining a first overlapping zone based on the first closed path; and
determining a second overlapping zone based on the second closed path.

12. The system of claim 8, wherein the one or more processing devices are further configured to determine the visual order of the intertwining vector objects within each of the one or more overlapping zones by comparing the locations of the closed paths of the intertwining vector objects with locations of the one or more overlapping zones of the intertwining vectors objects.

13. The system of claim 8, wherein the one or more processing devices are further configured to determine the visual order of the intertwining vector objects within each of the one or more overlapping zones by iterating through the intertwining vector objects in reverse z-order.

14. The system of claim 13, further comprising:
generating a temporary array; and
adding a highest object of the intertwining vector objects to a top position of the temporary array based on iterating through the intertwining vector objects in reverse z-order.

15. A non-transitory computer readable medium storing executable instructions which, when executed by a processing device, cause the processing device to perform operations comprising:
determining, from a vector graphic file, one or more intertwine groups based on relative locations of clipping groups of vector objects in the vector graphic file;
determining one or more overlapping zones between intertwining vector objects of the vector graphic file by comparing locations of closed paths of the intertwining vector objects;
determining a visual order of the intertwining vector objects within each of the one or more overlapping zones;
receiving a user input to modify the visual order of the intertwining vector objects within a first overlapping zone of the one or more overlapping zones; and
modifying the visual order of the intertwining vector objects within the first overlapping zone by changing a highest vector object within the first overlapping zone without further user input.

16. The non-transitory computer readable medium of claim 15, wherein the operations further comprise receiving, in response to user interaction with a graphical user interface of a client device, a request to create a modifiable intertwine group for intertwining the vector objects within the vector graphic file.

17. The non-transitory computer readable medium of claim 15, wherein determining the visual order of the intertwining vector objects within each of the one or more overlapping zones comprises iterating through the intertwining vector objects in reverse z-order to determine the highest vector object of the intertwining vector objects.

18. The non-transitory computer readable medium of claim 17, wherein the operations further comprise:
generating a temporary array;
determining a first closed path of a first clipping group of the clipping groups of the vector objects; and
adding a first vector object of the intertwining vector objects based on the first vector object belonging to the first clipping group.

19. The non-transitory computer readable medium of claim 18, wherein the operations further comprise:
determining a second vector object of the intertwining vector objects based on determining that the second object does not belong to the clipping groups; and
adding the second vector object to a top position of the temporary array.

20. The non-transitory computer readable medium of claim 19, wherein modifying the visual order of the intertwining vector objects within the first overlapping zone by changing the highest vector object within the first overlapping zone without further user input comprises displaying, in a graphical user interface of a client device, the first vector object above the second vector object.
